(19) United States
(12) Patent Application Publication
(10) Pub. No.: US 2004/0081213 A1
(43) Pub. Date: Apr. 29, 2004

(54) Circuit for controlling laser currents

(76) Inventors: Karl Schrodinger, Berlin (DE); Jurgen Blank, Dusseldorf (DE)

Correspondence Address: LERNER AND GREENBERG, P.A., POST OFFICE BOX 2480, HOLLYWOOD, FL, 33022-2480, US

(21) Appl. No.: 10/330,940

(22) Filed: Dec. 27, 2002

(30) Foreign Application Priority Data
Oct. 29, 2002 (DE) 102 50 981.6

(51) Int. Cl. H01S 3/13; H01S 3/00

(52) U.S. Cl. 372/38.02

(57) ABSTRACT

A laser current control circuit for controlling laser currents has a plurality of laser drivers, each for setting a laser current. A first control device controls a basic and/or modulation current of the plurality of laser drivers. Each of the laser drivers is provided a further control device, for adjustment of the basic and/or modulation current of the respectively assigned laser driver. Preferably, the first control device contains a regulating device for regulating the basic and/or modulation current. The circuit thus enables central regulation in conjunction with individual adjustment of the laser currents.

### BACKGROUND OF THE INVENTION

### Field of the Invention

The present invention relates to a circuit for controlling laser currents in parallel optical laser drivers.

FIG. 1 shows a circuit of this general type according to the prior art. There, a laser regulation or control circuit provides voltages U4 and U6 via the current mirrors T5 and T6, by way of a reference laser or a laser control for all the laser drivers of the module or IC. The voltages control the current sources of all the laser drivers and thus define the laser currents (I4, I2, IVCSEL where IVCSEL=I4−I2, I2 modulated).

One disadvantage associated with that prior art system is that the individual laser currents cannot be set individually. Although this disadvantage could be avoided by a mutually independent control of the individual lasers, since an individual current value could then be stored in digital or analog form for each laser, it is none the less the case that if the lasers are also intended to be able to be regulated, then this would only be possible with a high outlay (e.g. through separate monitor diodes for each laser driver).

### SUMMARY OF THE INVENTION

It is accordingly an object of the invention to provide a circuit for controlling laser currents which overcomes the above-mentioned disadvantages of the heretofore-known devices and methods of this general type.

With the foregoing and other objects in view there is provided, in accordance with the invention, a circuit for controlling laser currents, comprising:

a plurality of laser drivers, each for setting a laser current;

a first control device for controlling one of a basic current and a modulation current of the plurality of laser drivers; and

a further control device for each of the laser drivers, for adjusting one of the basic current and the modulation current of a respectively assigned the laser driver.

In other words, the invention provides a circuit for controlling laser currents, having: a plurality of laser drivers, each for setting a laser current; a first control device for controlling a basic and/or modulation current of the plurality of laser drivers; and for each of the laser drivers a further control device? for adjustment of the basic and/or modulation current of the respectively assigned laser driver.

Preferably, the first control device contains a regulating device for regulating the basic and/or modulation current. In accordance with an added feature of the invention, the regulating device comprising a reference laser, and the regulating device being designed to regulate the basic and/or modulation current in a manner dependent on an input or output signal of the reference laser.

In accordance with an additional feature of the invention, the further control devices each having an interface for receiving a control signal. The control signal may be either an analog or a digital control signal and the interface will be constructed accordingly.

In accordance with another feature of the invention, the circuit is designed as an integrated circuit and contains a memory device for storing data which contain information about the control signals for the further control devices.

In accordance with a concomitant feature of the invention, the circuit is designed as an integrated circuit and comprises a microcontroller for generating the control signals for the further control devices.

A circuit is thus provided which enables central regulation in conjunction with individual adjustment of the laser currents.

Central regulation has the advantage that, by way of example, it is thus possible to compensate for temperature influences for all the lasers jointly. The individual control makes it possible to achieve a higher yield for the circuit. In particular, it is possible to compensate for fluctuations in the specifications of the individual components (lasers, coupling optics, current sources) which can occur during semiconductor fabrication and have the effect that the required specification of the overall circuit is not complied with.

To that end, it suffices if the adjustment takes place in a specific framework, e.g. in the framework of plus/minus a few percent of the basic and/or modulation current. With reference to FIG. 1, although the lasers are intended to be able to have a basic current (I2, I4) that deviates individually by a few percent, all the currents I2(1 . . . n), I4(1 . . . n) of the laser drivers 1 . . . n are nevertheless intended to change in the same ratio as the currents I4*, I2* in the case of readjustment by regulation.

Other features which are considered as characteristic for the invention are set forth in the appended claims.

Although the invention is illustrated and described herein as embodied in a circuit for controlling laser currents, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a circuit diagram of a circuit for laser regulation according to the prior art;

FIG. 2 is a circuit diagram of a circuit for laser regulation according to a configuration of the invention;

FIG. 3 is a circuit diagram of a digital controller for the adjustment of a regulated basic current; and

FIG. 4 is a table showing parameters of the transistors of the digital circuit illustrated in FIG. 3.

### DESCRIPTION OF THE PREFERRED EMBODIMENTS

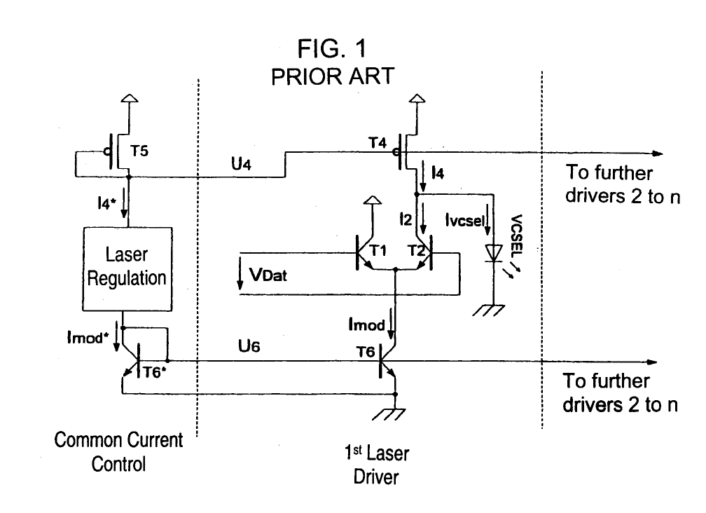

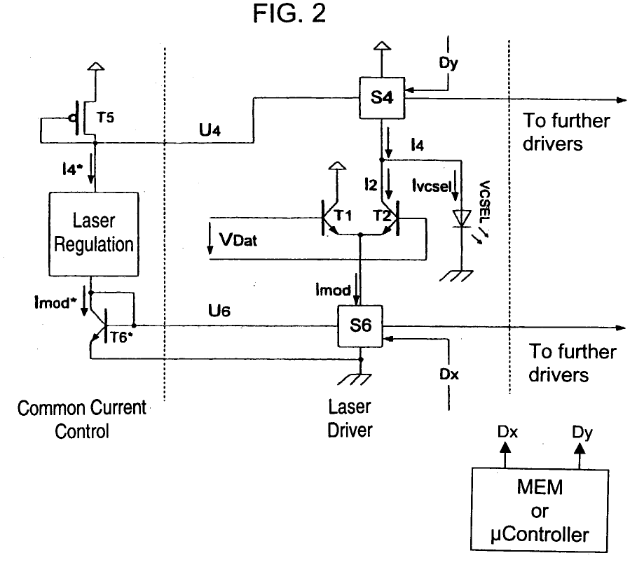

Referring now to the figures of the drawing in detail and first, particularly, to FIG. 2 thereof, there is shown a circuit for laser regulation according to a configuration of the invention. The transistors T4 and T6 of the prior art illustrated in FIG. 1 are replaced by circuits S4 and S6, respectively. The circuits are controlled, on the one hand, by the voltages U4 and U6; on the other hand, the currents Imod (and thus also I2) and I4 can also be varied by certain amounts in the circuits S4 and S6 by means of the digital or analog signals Dx, Dy.

Information represented by the signals Dx and Dy is stored in a memory “on chip,” an external storage medium, or a microcontroller. Furthermore, it is possible to bring about a change in the trimming adjustment via an external interface also during operation of the circuit. In particular, the interface may be enabled to receive digital control signals.

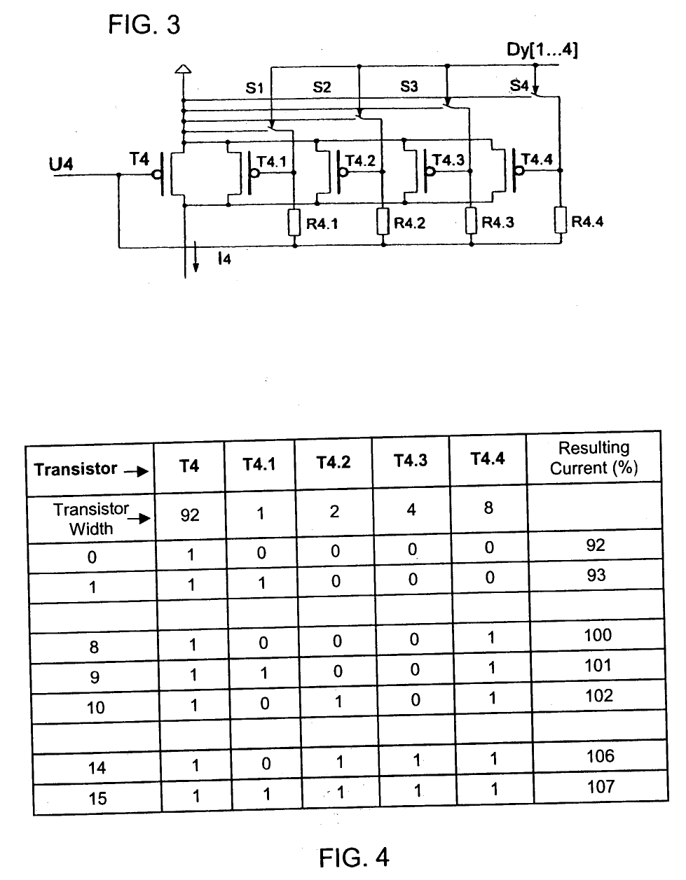

FIG. 3 shows an exemplary embodiment of a digital controller. The circuit corresponds to the block S4 in FIG. 2 and has a transistor T4 (corresponding to transistor T4 in FIG. 1), with which four further transistors T4.1 to T4.4 are connected in parallel. The transistors T4.1 to T4.4 can be activated by the switches S1 to S4 and thus increase the current proportionally in relation to their respective transistor parameter (e.g. the width in the case of MOS transistors).

Resistors R4.1 to R4.4 serve for decoupling the respective gate voltage. The resistors can also be replaced, if appropriate, by further switches which are driven in inverse fashion with respect to the switches S1-S4. The current factor can be set by corresponding dimensioning of the transistors.

A similar digital control can also be used for the block S6 in FIG. 2. In contrast to the control in FIG. 3, however, this would be realized by NPN or N-MOS transistors and set the current for the modulator.

Exemplary (relative) parameters of the transistors of the digital controller of FIG. 3 are contained in the table of FIG. 4. The binary numbers in the table represent the switching state of the transistors (1=switched on; 0=switched off). The transistor T4 is always switched on (by definition). A change in current of ±7% can thus be achieved.

The numbers in the first column of the table correspond to the digital values 0-15 of Dx, Dy.

It will be understood that the invention is not restricted to the exemplary embodiment described, but rather encompasses modifications in the context of the scope of protection defined by the claims.

We claim:

1. A circuit for controlling laser currents, comprising:
a plurality of laser drivers, each for setting a laser current;
a first control device for controlling one of a basic current and a modulation current of said plurality of laser drivers; and
a further control device for each of said laser drivers, for adjusting one of the basic current and the modulation current of a respectively assigned said laser driver.

2. The circuit according to claim 1, wherein said first control device comprises a regulating device for regulating one of the basic current and the modulation current.

3. The circuit according to claim 1, wherein said regulating device comprises a reference laser, and said regulating device is configured to regulate one of the basic current and the modulation current in dependence on one of an input signal and output signal of said reference laser.

4. The circuit according to claim 1, wherein said further control devices each has an interface for receiving a control signal.

5. The circuit according to claim 4, wherein said interface is configured to receive an analog control signal.

6. The circuit according to claim 4, wherein said interface is configured to receive a digital control signal.

7. The circuit according to claim 4 implemented in an integrated circuit and containing a memory device for storing data containing information about the control signals for said further control devices.

8. The circuit according to claim 4 implemented in an integrated circuit and comprising a microcontroller for generating the control signals for said further control devices.
